(19) United States
(12) Patent Application Publication
(10) Pub. No.: US 2004/0055766 A1
(43) Pub. Date: Mar. 25, 2004

(54) Fire suppression system and method

(75) Inventor: Mark Hayes, Calgary (CA)

Correspondence Address: OGILVY RENAULT, 1981 MCGILL COLLEGE AVENUE, SUITE 1600, MONTREAL, QC, H3A2Y3, CA

(73) Assignee: JUST-IN CASE FIRE LTD., Calgary (CA)

(21) Appl. No.: 10/251,796

(22) Filed: Sep. 23, 2002

(51) Int. Cl. A62C 3/07

(52) U.S. Cl. 169/62

(57) ABSTRACT

A structural fire suppression system is provided. The system incorporates the water supply and connects and accelerated pump system to the tank. The pump also communicates with a source of known fire suppression material to be mixed and subsequently distributed via conduits throughout either the duct work in a structure or behind the existing walls. The result is a short term fire suppression system which avoids disastrous effects in emergency.

### CROSS-REFERENCE TO RELATED APPLICATIONS

This is the first application filed for the present invention.

### TECHNICAL FIELD

The present invention relates to fire suppression system and method and more particularly, the present invention relates to a suppression system which is independent of municipal water supplies, municipal electrical supplies and which is self-contained within a building.

### BACKGROUND OF THE INVENTION

Fire suppression and protection systems have been previously proposed in a panacea of different methods and devices to either suppress or otherwise completely soak a structure.

Typical of the existing art in this field is that which is illustrated in U.S. Pat. No. 3,583,490, issued Jun. 8, 1971, to McFadden. In the arrangement, a plurality of conduits are arranged for wetting the exterior portion of the structure and the general vicinity surrounding the structure. The source of water in this instance is provided by a pool and the water is removed from the pool by a suitable starter and battery arrangement.

This would appear to be an effective system, however, it requires extensive amount of water to achieve the desired result.

A further variation on the external fire protection arrangements is illustrated in U.S. Pat. No. 4,428,434, issued Jan. 31, 1984, to Gelaude.

In the reference, an automatic fire damage system is provided incorporating sensors and amplifiers to detect temperature variations concomitant with those that would be experienced in a fire.

Similar to U.S. Pat. No. '490, the arrangement in this patent relies on the use of sprinkler heads placed on the roof or about the parameter of the structure to be protected. In this arrangement, the swimming pool provides the source of water which is passed into conduits linked to the sprinkler heads via a pumping arrangement.

In yet another variation, Banzato, in U.S. Pat. No. 3,179,181, issued Apr. 20, 1965, provides a roof top mounted sprinkler system. In the above-noted systems, all of the arrangements require extensive modification to the structure with which they are integrated. This not only leads to exposure of the devices to the elements, but also detracts from the appearance of the residence.

In U.S. Pat. No. 5,909,983, issued Jun. 8, 1999, to McGee, Jr., an emergency water reservoir arrangement is set forth. In the device, a subterranean water storage tank communicates with a water hydrant valve. The arrangement provides water intake conduit which is connected to an established water supply. The pumping arrangement pumps the water from the reservoir to the hydrant and the device is driven by an electrical power generator to provide backup power to the water pump in the event of electricity failure or cut off. As with the other established in the art, this device provides utility, but with a few drawbacks. First, the water tank must be provided for in a subterranean disposition as with the pump and electrical devices. Further, the system is fairly elaborate and as is known, the more elaborate arrangements tend to be, the greater the proclivity for failure.

Ros, in U.S. Pat. No. 5,806,602, issued Sep. 15, 1998, provides a quick acting air foam delivery device. The arrangement provides an air compressor, water tank foaming liquid reservoir and a fire hose through which the mixture may be rejected.

Other arrangements in the art that achieve general fire suppression or extinguishing features include U.S. Pat. Nos. 6,089,324; 5,906,176; 5,979,563; 5,366,021; 5,632,338; 3,682,250; 3,702,159; 5,211,246; 3,783,946; 5,881,817; 5,240,078; 6,346,203; and 5,125,458.

It would be desirable to have a fire suppression system whereby a volume of water from, for example, the hot water tank of a residence could be linked to a suitable pump and foam material and this material mixed and distributed through out all of the rooms or selected rooms in a residence in order to provide protection to inhabitants until such time as fire professionals arrive on the scene. Further, it would be very desirable to have a completely independent system which is independent of the electricity mains and water mains and can be put into use almost instantaneously. The present invention satisfies these needs in the art.

### SUMMARY OF THE INVENTION

One object of one embodiment of the present invention is to provide a residential fire suppression system, comprising:

a water supply;

pump means connected to the water supply;

fire suppression material connected to the pump means;

a manifold for distributing a mixture of water and the fire suppression material;

fixed conduit means networked internally of the structure for discharging the mixture to predetermined locations in the structure; and

a power source connected to the pump means independent of a main electrical supply, the power source for supplying power to the pump means.

A further object of one embodiment of the present invention is to provide a kit for suppressing fire, the kit comprising:

a pump having connection means for connection with a hot water tank;

a battery for connection to the pump;

a manifold conduit means for connection to the manifold, the conduit means for networking interiorly of the structure; and

fire suppression material for connection to the pump for mixture with water and distribution through the conduits.

Yet another object of one embodiment of the present invention is to provide a method of providing short term fire suppression within a structure, comprising the steps of:

providing a pump means having:

a power supply independent of the main electrical supply for the structure;

a pump connection means for connection to a hot water tank;

distribution means for distributing fire suppression material;

providing flexible conduits for connection with the distribution means;

position the conduits through walls of the residence with openings at predetermined locations; and

distributing fire suppression material through the conduits at the predetermined locations upon the breakout of fire.

Having thus described the invention, reference will now be made to the accompanying drawings illustrating preferred embodiments.

### BRIEF DESCRIPTION OF THE DRAWINGS

FIG. 1 is a schematic illustration of the arrangement according to one embodiment of the present invention;

FIG. 2 is a schematic illustration of the system in situ, and in particular, behind the walls of a typical structure;

FIG. 3 is a schematic illustration of a further embodiment of the present invention;

FIG. 4 is a section along line 4-4 of FIG. 2;

FIG. 5 is a section along line 5-5 of FIG. 2; and

FIG. 6 is an enlarged view of a conduit connection.

Similar numerals in the figures denote similar elements.

### DETAILED DESCRIPTION OF THE PREFERRED EMBODIMENT

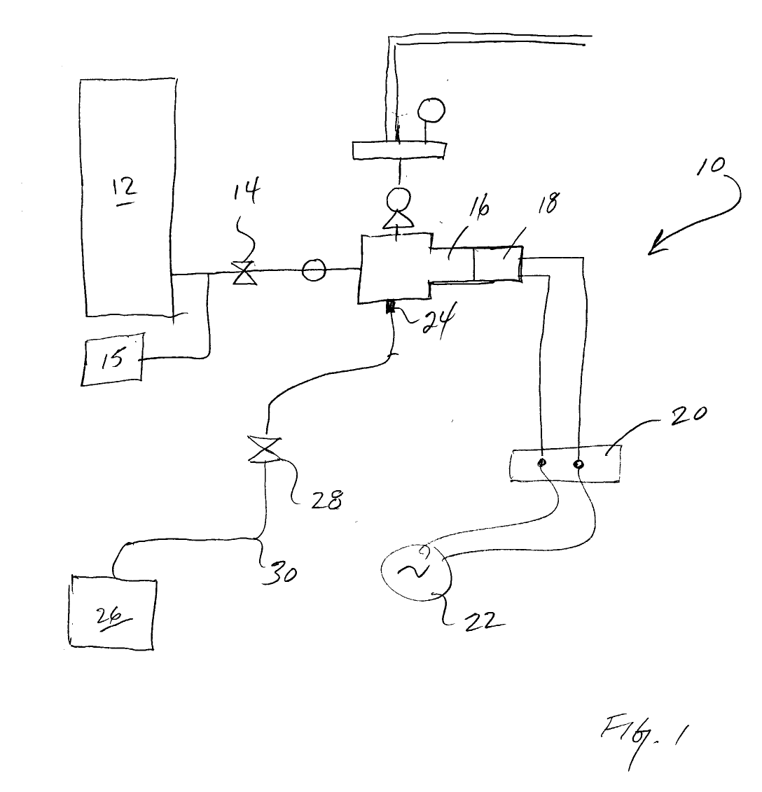

Referring now to FIG. 1, in the illustration the overall system is denoted by numeral 10 with the source of water being composed of hot water tank 12. Tank 12 is a conventional hot water tank which is typically connected to the municipal water supply (not shown) and includes a conventional rotatable valve 14 for connection with the plumbing of a residence (not shown). In this embodiment, the valve 14 is connected to a filter 15 and then a pump 16 having a motor 18 attached thereto. The motor is driven by a conventional battery 20, which battery 20 is periodically recharged by the mains 22 of the structure. Pump 16 includes a suction line 24 which suction line communicates with a source of fire suppression material 26 which is simply positioned adjacent the pump 16. A valve, in this case a check valve 28 is positioned in line with a conduit 30 extending from the suppression material 26 to the opening 24 for the line. The opening 24 simply acts as a suction point which is normally attributable to pumps of all varieties. In order to further enhance the pressure in the system, a booster or pump accelerator 32 may be included in the arrangement. The booster or accelerator 32 communicates with a distribution manifold 34 which is connected to, in the example, a rigid conduit 36. Although one conduit is shown in FIG. 1, it will be evident that the manifold 34 plurality of portals for connection with conduits 36.

In the embodiments shown in FIG. 1, the system provides a self-contained unit for fire suppression to allow the escape of any trapped persons of a residence. This is achievable since the conventional water tank, shown in the example and denoted by numeral 12, can hold 40 gallons or more of water and this taken in combination with the fire suppression material 26 provides several minutes distribution of foam material through the conduits 36 allowing additional margin of time for escape.

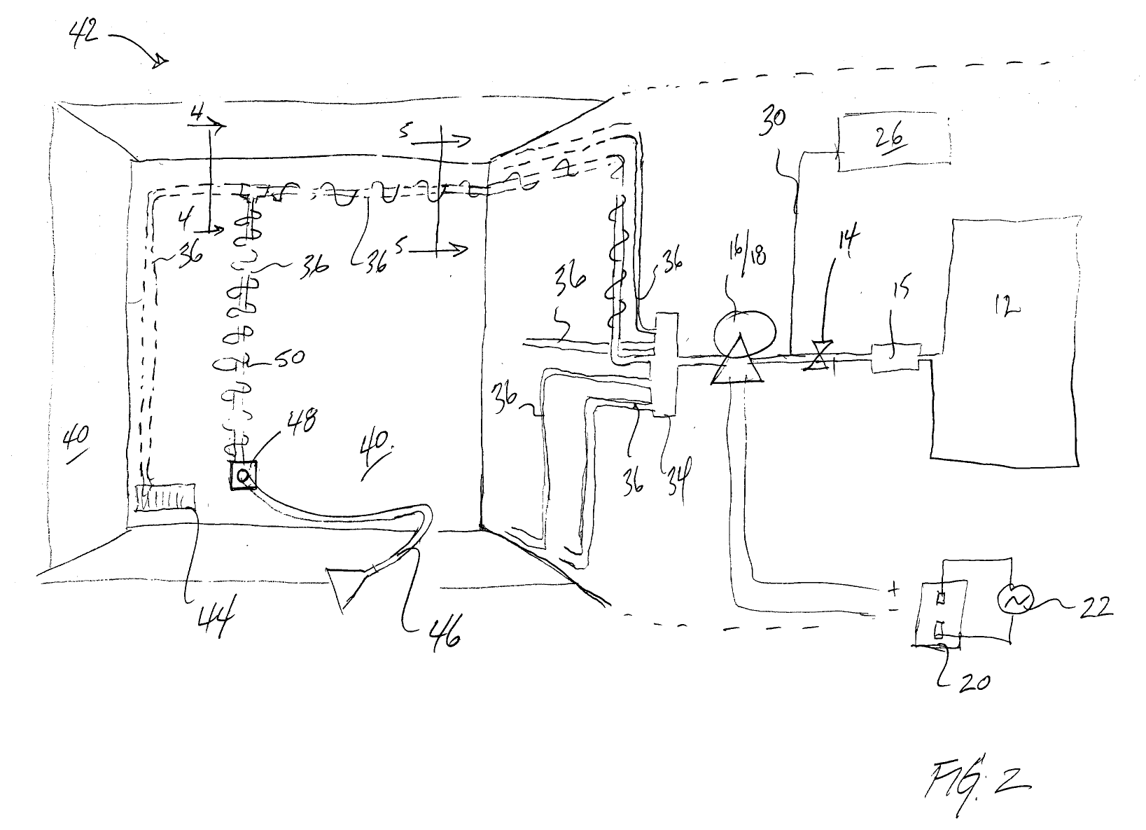

FIG. 2 illustrates one possible example where the system is positioned in situ within the walls of a room. The walls are denoted by numeral 40, the room being represented globally by numeral 42.

In this embodiment, the conduits 36 are positioned behind wall 40 as indicated by the fact that they are demonstrated in dotted line. The conduits 36 obviously extend back to the manifold 34 and communicate with the apparatus as set forth in respect of the description for FIG. 1. At the terminal ends of the conduits 36, there are a variety of options one of which includes the connection of conduit 36 to a conventional hose receptable 37 which is hidden in the wall by register cover 44. For these features, reference is made to FIG. 6. The register cover is connected to the wall with a quick release latch broadly denoted by numeral 39 in lieu of the construction standard wood screws. In this manner, in the event of a fire occurrence, the system can be activated by removing the register 44, connecting the discharge hose and nozzle 46 to the hose receptacle 37 and subsequently discharging the foam mixture into the room 42. The discharge of the foam may be activated by making a connection between the nozzle 46 and the outlet similar to the conventional central vacuum system or a normal toggle switch (not shown) may be placed a the location of the hose receptacle.

It will be understood that quick release mechanism 39 may comprise any suitable means.

As an alternative or to be used in conjunction with the register system is a second system where the discharge hose and nozzle 46 is connected to an outlet 48 positioned in wall 40. Outlet 48 is similar to conventional central vacuum systems and to this end, outlet 48 includes an electrical connection 50 which extends back to the battery 20. Once a connection is made between the nozzle and conduit 46 with outlet 48, the system is activated and the foam may be discharged from nozzle 46.

Referring now to FIG. 3, shown is a further embodiment where the overall system includes a plurality of conduits 36 which terminate at registers 44. In this embodiment, the foam may be discharged with the register face 44 simply removed in an emergency situation. In this embodiment, the conduits 36 may be positioned within the duct work 45 of the residence.

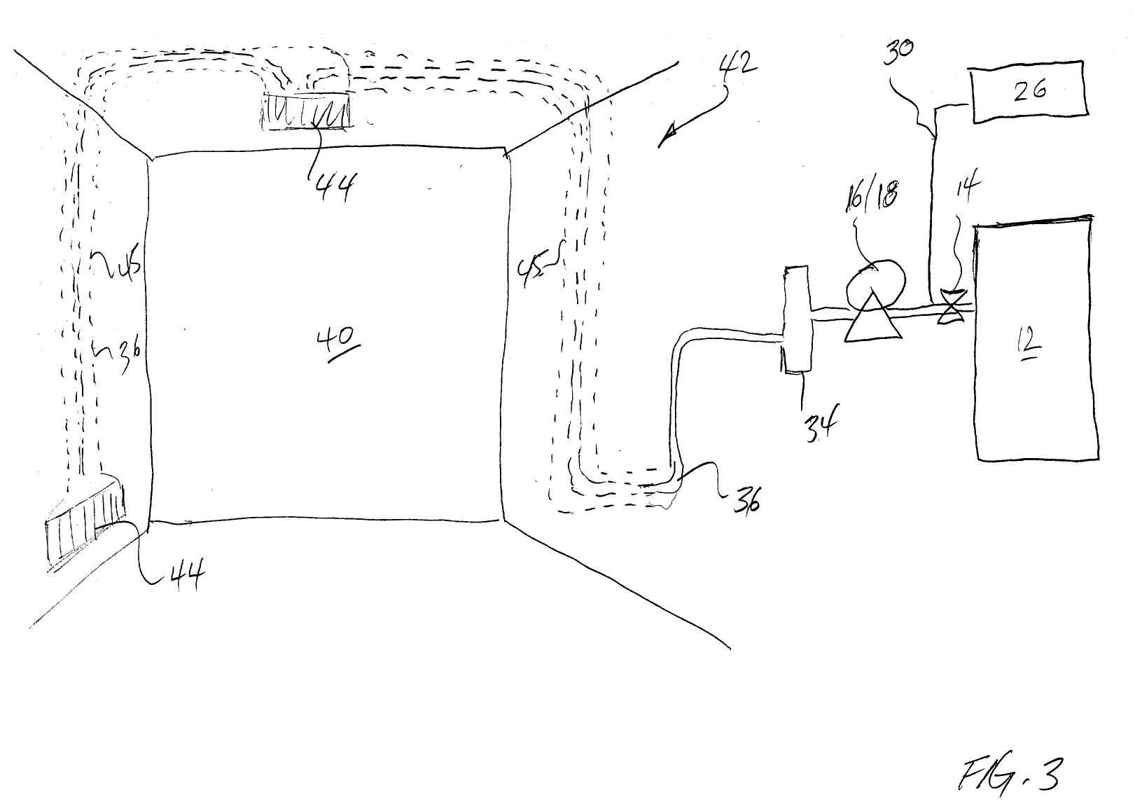

Referring now to FIG. 4, shown is a sectional view along line 4-4 of FIG. 2. In this embodiment, the conduit 36 comprises a ridged tube conduit such as that which is typically found in residential vacuum systems, a suitable clip 50 may be provided to secure the conduit 36 against the undersurface of wall 40.

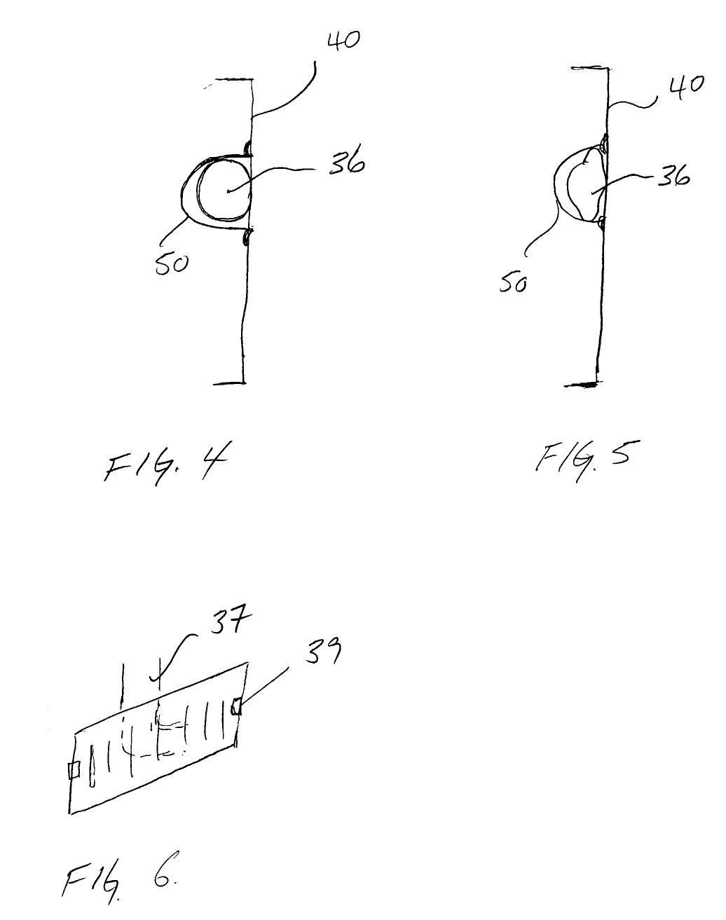

With respect to FIG. 5, shown is an embodiment where the conduit is of a flat nature or flexible material typically encountered in fire hose applications.

It will be understood that in either of the systems, conduits 36 may comprise either one hard or flexible tubing or a combination of these.

Although embodiments of the invention have been described above, it is not limited thereto and it will be apparent to those skilled in the art that numerous modifications form part of the present invention insofar as they do not depart from the spirit, nature and scope of the claimed and described invention.

I claim:

1. A structural fire suppression system, comprising:
a water supply;
pump means connected to said water supply;
fire suppression material connected to said pump means;
a manifold for distributing a mixture of water and said fire suppression material;
fixed conduit means networked internally of said structure for discharging said mixture to predetermined locations in said structure; and
a power source connected to said pump means independent of a main residential electrical supply, said power source for supplying power to said pump means.

2. The fire suppression system as set forth in claim 1, wherein said structural water supply comprises a hot water tank.

3. The fire suppression system as set forth in claim 1, wherein said conduit means comprises flat tubing.

4. The fire suppression system as set forth in claim 1, wherein said conduit means comprising ridged tubing.

5. The fire suppression system as set forth in claim 1, wherein said conduit means is networked through duct work of said structure.

6. The fire suppression system as set forth in claim 1, wherein said conduit means comprises a combination of flexible flat tubing and ridged tubing.

7. The fire suppression system as set forth in claim 1, wherein said system includes water tank connection on said pump means.

8. The fire suppression system as set forth in claim 1, wherein said system further includes a booster pump for accelerating a flow of said mixture through said conduit means.

9. The fire suppression system as set forth in claim 1, wherein said distribution means includes a plurality of ports in said conduit means.

10. The fire suppression system as set forth in claim 1, wherein said fire suppression material comprises a supply of material independent of said pump means.

11. A kit for suppressing fire in a structure, said kit comprising:
a pump having connection means for connection with a hot water tank;
a battery for connection to said pump;
a manifold conduit means for connection to said manifold, said conduit means for networking interiorly of said structure; and
fire suppression material for connection to said pump for mixture with water and distribution through said conduits.

12. A method of providing short term fire suppression within a structure, comprising the steps of:
providing a pump means having:
a power supply independent of the main electrical supply for said structure;
a pump connection means for connection to a residential hot water heater/tank;
distribution means for distributing fire suppression material;
providing flexible conduits for connection with said distribution means;
position said conduits through walls of said structure with openings at predetermined locations; and
distributing fire suppression material through said conduits at said predetermined locations upon the breakout of fire.

13. The method as set forth in claim 12, further including the step of providing sensor means connected to said pump means for activating said pump at a predetermined temperature.

14. The method as set forth in claim 12, further including the step of mixing said fire suppression material with water.

15. The method as set forth in claim 12, further including the step of accelerating said mixture through said conduit means.

16. The method as set forth in claim 12, wherein said predetermined locations comprise register openings of said residence.
